(19) United States
(12) Patent Application Publication
(10) Pub. No.: US 2003/0149587 A1
(43) Pub. Date: Aug. 7, 2003

(54) Method and system for processing obsolete goods

(76) Inventors: Brenda Lawrence, Detroit, MI (US); Gail Travis, Novi, MI (US); John Ang, Ypsilanti, MI (US); Peter Kowaleski, Dearborn, MI (US)

Correspondence Address: BROOKS & KUSHMAN P.C./FGTL, 1000 TOWN CENTER, 22ND FLOOR, SOUTHFIELD, MI, 48075, US

(21) Appl. No.: 10/315,876

(22) Filed: Dec. 10, 2002

Related U.S. Application Data
(60) Provisional application No. 60/339,145, filed on Dec. 11, 2001.

(51) Int. Cl. G06F 17/60

(52) U.S. Cl. 705/1; 705/22

(57) ABSTRACT

In a system embodiment, a client-server computing architecture (i) receives defining a supplier's claim for payment for obsolete goods, (ii) receives input scheduling an audit of the supplier's claim, (iii) receives input defining one or more results of the audit, and (iv) presents output reconciling the supplier's claim with the audit results. System supports approving payment and defining disposal instructions for the obsolete goods. A method embodiment includes establishing a buyer-supplier contractual arrangement, communicating to the supplier that a portion of the quantity of the goods are obsolete, receiving an electronic claim from the supplier requesting payment for the obsolete goods, electronically scheduling an audit of the supplier's claim, auditing the supplier's claim and recording the audit results electronically, and paying the supplier for the obsolete goods. A payment price for the obsolete goods may be negotiated.

### CROSS-REFERENCE TO RELATED APPLICATIONS

This application claims the benefit of U.S. provisional application Serial No. 60/339,145, filed Dec. 11, 2001.

### BACKGROUND OF THE INVENTION

1. Field of the Invention

The present invention refers generally to supply-chain business practices and web-based communication technologies.

2. Background Art

Within the manufacturing industry, it is not uncommon for an unexpected design or production program change to take place that results in a surplus of parts, materials or other supply-chain goods. For example, if a particular automobile engine is unexpectedly cancelled in a given automobile production program at the automobile assembly level, all of the suppliers supplying the materials, parts and assemblies that made up the engine are left with quantities of obsolete supply chain goods. Obsolete engines may already be assembled and packaged at supplier warehouses. In addition, half-assembled engines and bins of unused parts may be stockpiled at supplier assembly facilities. Further down the supply chain, raw materials intended to make up the parts that make up the engine are obsolete as well.

Typically, however, the manufacturer (or other supply chain buyer) will have already entered into a contractual arrangement with their respective suppliers obligating both payment by the buyer and delivery by the supplier. In these instances, a settlement must be reached between the buyers and suppliers in terms of how the obsolete materials, parts, assemblies, etc. will be paid for and “disposed” of.

Conventional methods for settling supply agreements in view of obsolete parts involve pencil-and-paper and face-to-face or telephone-type business dealings. In some instances, an auditor representing the buyer will physically visit the supplier to view and account for the obsolete parts and their condition or stage of development prior to arranging settlement and disposal with the supplier.

Although steps have been taken within the manufacturing industry to automate or otherwise computerize a process for handling obsolete goods, the prior art lacks the novel features and advantages of the present invention. For example, prior art systems were mainframe-based and required a proprietary or dedicated link to the computer systems managing the relevant data.

In addition, prior art systems lack efficient interfaces for conducting many of the activities associated with processing supplier claims for obsolete parts (e.g., submitting/receiving supplier claims, reviewing the claims, scheduling supplier audits, inputting audit results, approving payment for the obsolete goods, defining disposal instructions for the goods, supporting efficient and effective communication between the buyer and supplier, etc.).

### SUMMARY OF THE INVENTION

The present invention provides both buyers and suppliers in the manufacturing industry with an effective tool and methodology for submitting, reviewing, auditing approving and generally processing supplier claims for obsolete goods.

One advantage of the present invention is that it may be implemented in a Web-based format facilitating access by any authorized party at any time from any place. As opposed to prior-art systems, users of the present invention will enjoy access to up-to-date data hosted within a central data repository.

One embodiment of the present invention is a system for processing obsolete goods in a supply chain. According to this embodiment, the system comprises a client-server computing architecture operably configured to: (i) receive input via one or more graphical user interfaces defining a supplier's claim for payment for obsolete goods, (ii) receive input via one or more user interfaces scheduling an audit of the supplier's claim, (iii) receive input via one or more graphical user interfaces defining one or more results of the audit; and (iv) present output via one or more graphical user interfaces reconciling the supplier's claim with the audit results.

A system embodiment of the present invention may be additionally configured to receive input via one or more graphical user interfaces approving payment for the obsolete goods.

A system embodiment of the present invention may be additionally configured to receive input via one or more graphical user interfaces defining disposal instructions for the obsolete goods.

A system embodiment of the present invention may be additionally configured to query one or more databases operably configured to store at least a portion of the input information.

A system embodiment of the present invention may be additionally configured to print at least a portion of the input information. This information may be printed in a report format.

Another embodiment of the present invention is a method for processing obsolete goods in a supply chain. The method may include (i) establishing a contractual arrangement between a buyer of goods and a supplier of the goods such that the supplier is obligated to supply a quantity of the goods and the buyer is obligated to pay for the quantity of the goods, (ii) communicating to the supplier that a portion of the quantity of the goods are obsolete, (iii) receiving an electronic claim from the supplier over a computer network requesting payment for the obsolete goods, (iv) scheduling an audit of the supplier's claim in an electronic fashion over the computer network, (iv) auditing the supplier's claim wherein the results of the audit are recorded in an electronic fashion over the computer network, and (v) paying the supplier for the obsolete goods.

A method embodiment of the present invention may additionally include defining disposal instructions for the obsolete goods and communicating the disposal instructions to the supplier.

A method embodiment of the present invention may additionally include verifying the supplier's claim wherein the buyer confirms that the portion of the quantity of the goods are obsolete with regard to the buyer's entire enterprise.

The step of auditing the supplier's claim may include negotiating a payment price for the obsolete goods.

These and other embodiments of the present invention support other advantages and features such as those described in the detailed description of the preferred embodiments and claims, and as illustrated in the accompanying drawings.

### BRIEF DESCRIPTION OF THE DRAWINGS

FIG. 1 is a block flow diagram illustrating a preferred methodology for implementing the present invention;

FIG. 2 is an example graphical user interface (GUI) for submitting a claim for payment and disposal of obsolete goods in accordance with a preferred embodiment of the present invention;

FIG. 3 is an example GUI through which an auditor can search and view claims that have previously been submitted by suppliers;

FIG. 4 is an example GUI through which an auditor can input the results of a supplier audit;

FIG. 5 is an example GUI through which an claim/audit reviewer can approve or reject payment for an audited claim and disposal of the obsolete goods;

FIG. 6 is an example GUI through which instructions on how the supplier is to dispose of obsolete goods are input; and

FIG. 7 is a schematic representation of an example system implementation of the present invention.

### DETAILED DESCRIPTION OF THE PREFERRED EMBODIMENT(S)

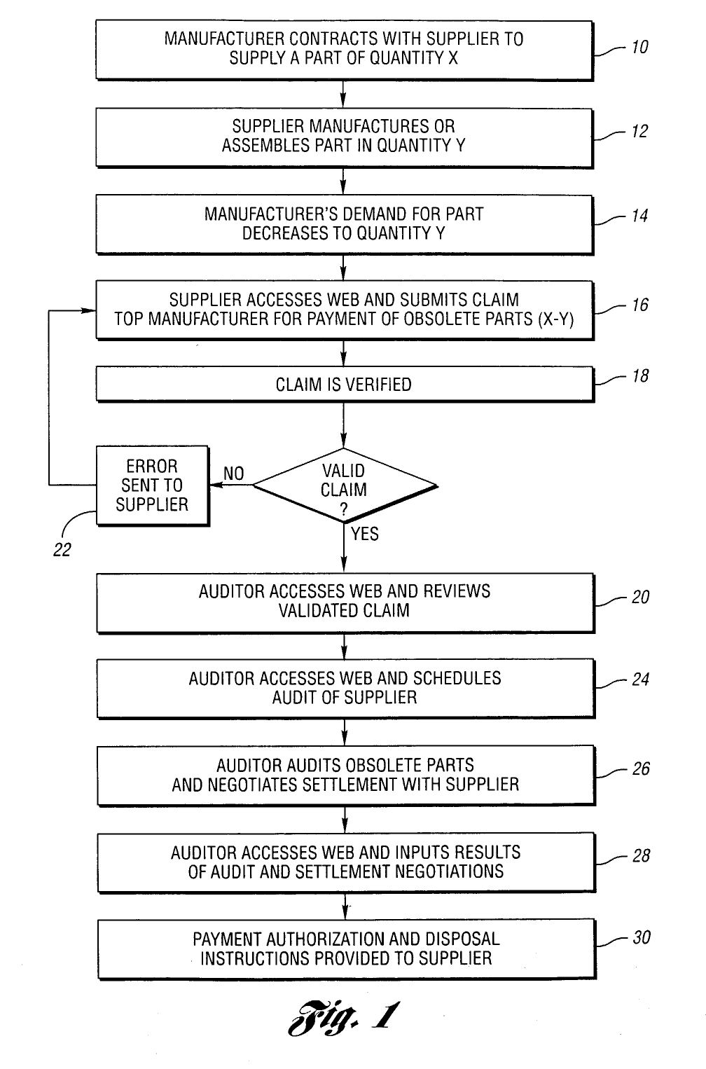

FIG. 1 is a block flow diagram illustrating a preferred methodology for implementing the present invention. Notably, the content or arrangement of the elements illustrated in FIG. 1 may be modified, supplemented or rearranged to best fit a particular implementation of the present invention.

For purposes of illustration only, aspects and embodiments of the present invention are illustrated and described in the context of the automotive industry. Those of ordinary skill in the fields of manufacturing, distribution, supply chain management, etc., recognize that embodiments of the present invention may be applied to a wide variety of industries in addition to the automotive industry.

As illustrated in block 10, a “buyer” (e.g., manufacturer, etc.) contracts with a “seller” (e.g., supplier, subcontractor, etc.) to supply a “good” (e.g., part, material, assembly, etc.) in quantity X. In view of this arrangement, the supplier manufactures or assembles the goods, as represented in block 12. In some instances, the supplier may manufacture/assemble the full requested quantity (X). In other instances, the supplier may manufacture/assemble a portion of the ordered quantity.

To illustrate embodiments of the present invention, it is assumed that the buyer's demand for the ordered goods is eliminated or reduced after the goods have been manufactured (or assembled) by the supplier, but before all of the ordered goods have been shipped to the buyer, thereby creating a quantity (X-Y) of “obsolete” goods as represented in block 14. Notably, this assumption may and will likely vary in view of a particular implementation of the present invention.

As represented in block 16, the supplier accesses a web-based aspect of the present invention to submit an online claim for payment and disposal of the obsolete goods. As represented in block 18, the supplier's online claim is verified in an online fashion by a claim reviewer. Claim verification may include (i) verifying the part number associated with the obsolete goods to ensure that the indicated goods are, in fact, obsolete, (ii) verifying the supplier associated with the claim, and (iii) verifying that no other plants that are owned or operated by the buyer have a demand for the obsolete goods.

If the submitted claim is invalid, an error message or other notice is sent to the supplier as represented in block 22. Typically, the supplier will correct the error and resubmit the claim. If the submitted claim is valid, an auditor reviews the validated claim in an online fashion and schedules an audit of the supplier's obsolete goods via the web as represented in blocks 20 and 24, respectively.

As represented in block 26, the auditor physically visits the supplier's plant(s) to audit the quantity, location and condition of the obsolete goods. In addition, the auditor may attempt to negotiate a settlement for compensating the supplier for the obsolete goods at a price that is different that the original contract price. Typically, the negotiated price is less than the original contract price. For example, a negotiated price may be based on the stage of completion of some parts. On these unfinished parts, the supplier may not have all the labor or part costs as in the finished product. Therefore, a negotiated price may be determined for the total of all parts which reflects the suppliers actual costs in the parts.

Following the audit, the supplier accesses a web-based aspect of the present invention to input and record the results of the audit and settlement negotiation as represented in block 28. Assuming that there are no problems with the claim, audit and settlement, payment to the supplier for the obsolete goods is authorized and disposal instructions for the goods are defined and forwarded to the supplier, as represented in block 30.

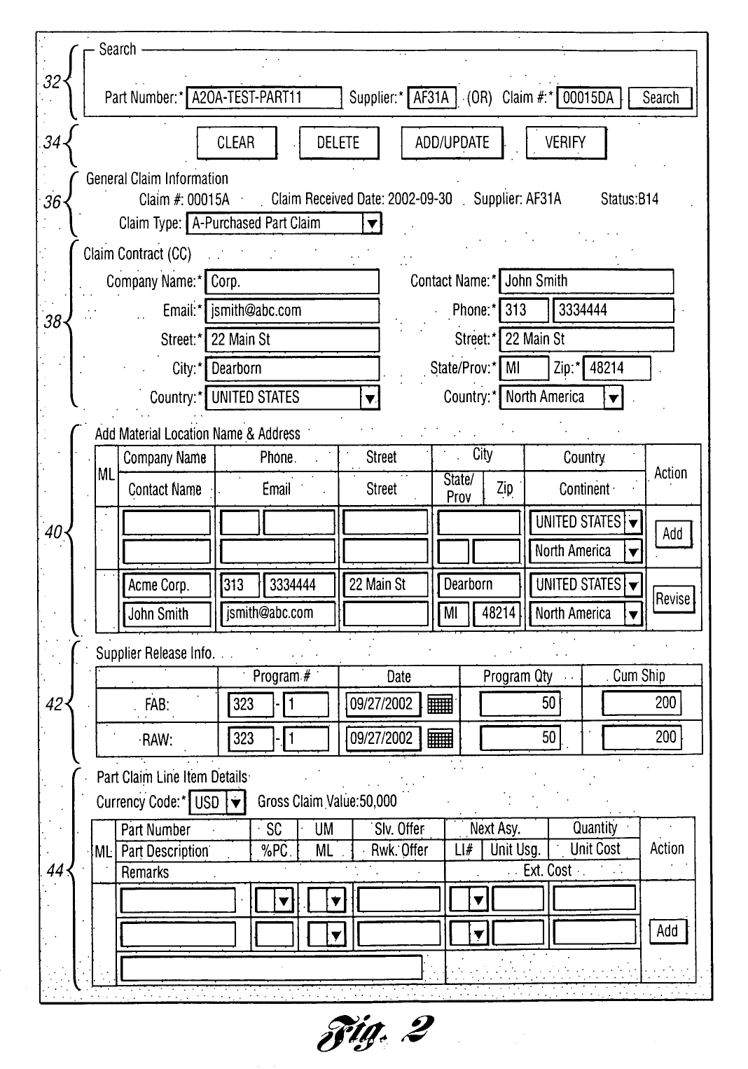

FIG. 2 is an example graphical user interface (GUI) for submitting a claim for payment and disposal of obsolete goods in accordance with a preferred embodiment of the present invention. Notably, the content or arrangement of the GUI illustrated in FIG. 2 may be modified, supplemented or rearranged to best fit a particular implementation of the present invention. Preferably, this GUI is implemented in a web-based fashion.

In region 32, a supplier submitting a claim can conduct a search of previously submitted claims by part number, supplier code or claim number to update or delete an existing claim. The user selects from buttons 34 to determine various claim-related actions to be taken (e.g., clear, delete, verify, add update, etc.).

In region 36, the general claim information is displayed—the claim number, the date the claim was received (if previously submitted), the supplier code, the status of the claim, and the claim type. A claim may have more than one status before it is complete or can be settled. Initially, these status codes may be error codes to make sure that the information on the claim is accurate and verified against the buyer's data. After any errors are resolved, the claim may be placed in a verified status. The claim may then enter an audit status, waiting for an auditor to complete his/her evaluation of the claim. Next, the claim may enter an approval status. Preferably, proper authorized approvals are required before a claim can be paid. Finally, a claim may move into a final disposition status.

Claim type may include a purchased part claim, a component part termination notice, a part sample warranty, etc. For example, claim type ‘A’ may refer to Purchase Part Claims, ‘B’ to Component Part Termination Notice Claims, ‘C’ for Part Sample Warranty Claims.

In region 38, the user inputs contact information for the entity submitting the claim (e.g., the supplier). In region 40, the user inputs the geographical location for the obsolete goods. This location may be different that the supplier contact location. In region 42, the user inputs details of the original buyer-supplier contract (e.g., the program number, the contract date, the program quantity, the cumulative shipment quantity, etc.). Program quantities are the quantities the buyer originally requested. Shipment quantities are the quantities of goods that have been received from the supplier. “FAB” refers to a fabricated or finished part. “RAW” refers to an unfinished part. For example, a finished part is the final part installed in a vehicle, and a RAW part is part of a finished “assembled” part.

In region 44, the user (supplier) inputs the actual claim for the obsolete goods. Claims may be broken up into line items. Table 1 below includes a description of various types of information that may be input in region 44.

TABLE 1

| Information | Description |
|---|---|
| Currency Code | An indicator of the supplier's |
| | currency type. |
| Line Item | A claim may have more than one line |
| | item. |
| Gross Claim Value | A claim can have numerous parts in |
| | which the supplier is claiming |
| | obsolescence. The Total Gross claim |
| | amount is the total number of parts |
| | multiplied by their negotiated cost, |
| | to the buyer, for all the parts on |
| | the claim. |
| Part Number | The buyer's number for the obsolete |
| | goods. |
| Part Description | A description of the obsolete goods. |
| Remarks | Remarks relating to the goods or |
| | claim. |
| SC-Material Stage of | A = Finished end item part |
| Completion | B = Purchased part |
| | C = Work in process part |
| | D = Raw material part |
| % PC | Percentage of Completion of the part |
| UM | Unit of Measure |
| ML-Material Location | ‘Company Name’, ‘Contact Name’, |
| | ‘Phone’ (Area and Phone), ‘Email’, |
| | ‘Street’ (at least one field), |
| | ‘City’, ‘State’, ‘Zip Code’, |
| | ‘Country’, and ‘Continent’ |
| Salvage Offer | When disposing of a canvassed part, a |
| | supplier may make a salvage offer, to |
| | Scrap the part. The buyer may then |
| | ship the part as “scrapped” to the |
| | supplier unless already at supplier. |
| Rework Offer | The cost to rework the part (may be |
| | based on an engineering change or |
| | deviation). |
| Next Assembly Line Item | Next part within the assembly. One |
| | or many parts can be assembled to |
| | form a Finished part (Final assembled |
| | part). |
| Next Assembly Unit Usage | Usage of that part on the assembled |
| | part (usually line item 1) |
| Next Assembly Quantity | Amount placed on the claim. |
| Next Assembly Unit Cost | Cost of the part to the buyer. |

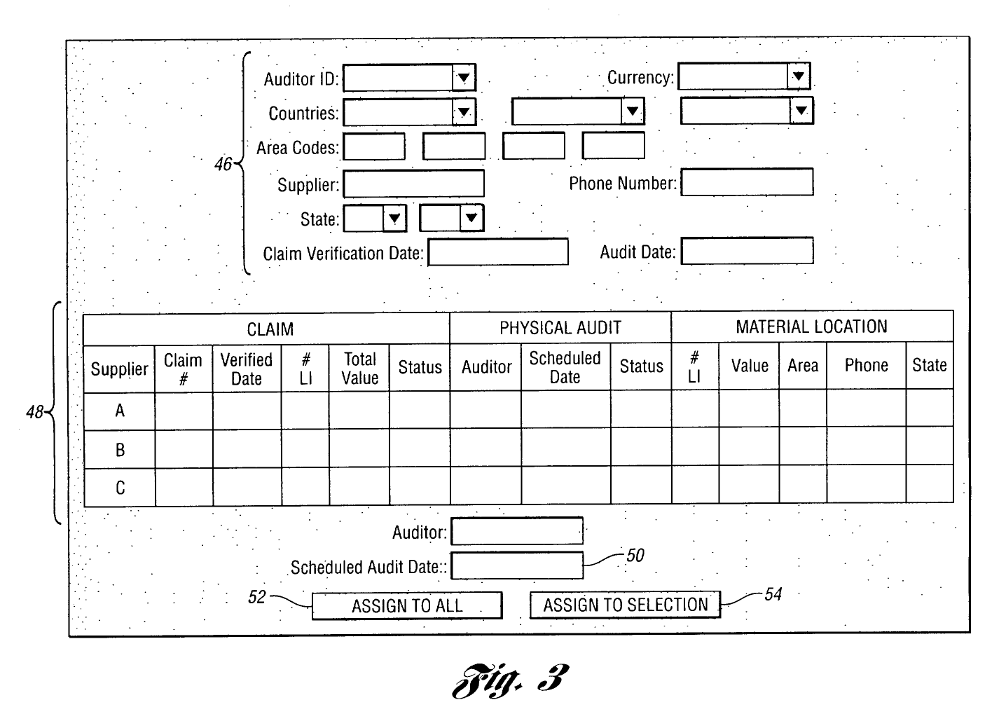

FIG. 3 is an example GUI through which an auditor can search and view claims that have previously been submitted by suppliers. Notably, the content or arrangement of the GUI illustrated in FIG. 3 may be modified, supplemented or rearranged to best-fit a particular implementation of the present invention. Preferably, this GUI is implemented in a web-based fashion.

In accordance with a preferred embodiment of the present invention, auditors audit claim categories according to certain claim criteria (e.g., type of technology, buyer program, geographic region, etc.). Similarly, claims themselves may be arranged or otherwise organized according to these types of criteria. In this respect, an aspect of the present invention is provided in which an auditor searching previously submitted claims will only view the claims that meet that auditor's previously-defined criteria. This aspect of the present invention may be automatically implemented in association with the auditor's “ID” selected in region 46.

In addition, an auditor may search submitted claims according to a variety of criteria including currency, country, area code, supplier code, supplier telephone number, supplier state, claim verification date and audit date. By selecting the “Search” button 48, a database of all submitted claims is queried. Search results are presented in region 48.

In region 48, an auditor can schedule an audit or view a previously scheduled audit. Audits that have not previously been scheduled will lack a “Scheduled Date” entry. This date may be input by the auditor in field 50 and assigned to one or more audits via buttons 52 and 54.

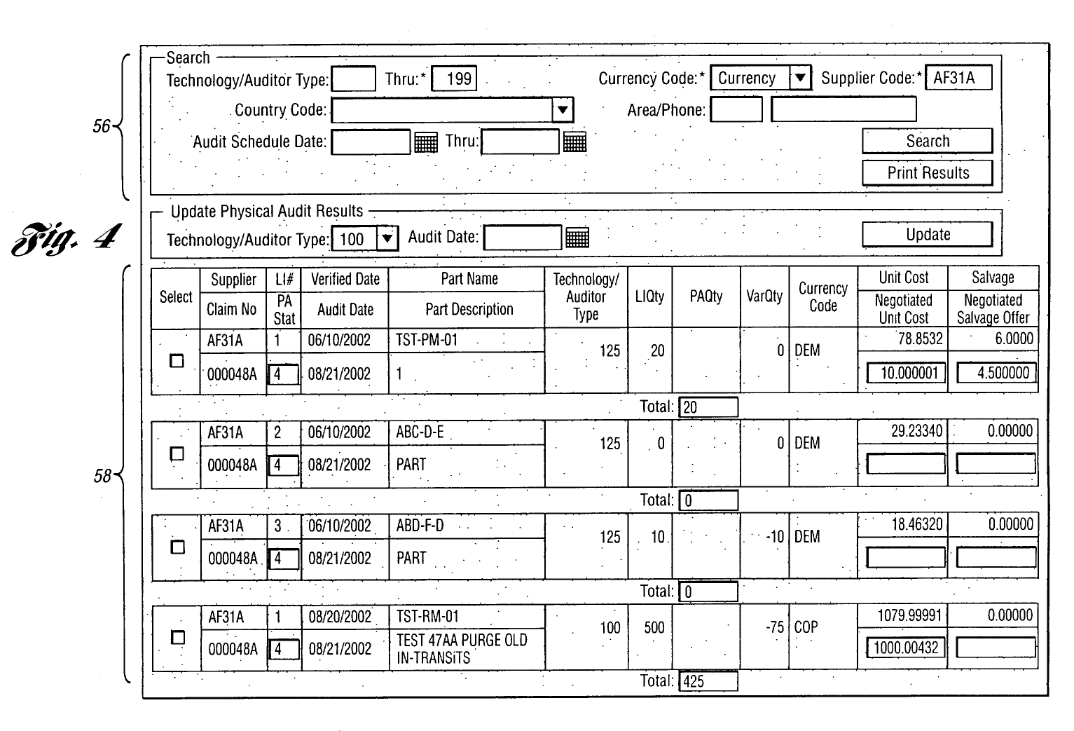

FIG. 4 is an example GUI through which an auditor can input the results of a supplier audit. Notably, the content or arrangement of the GUI illustrated in FIG. 4 may be modified, supplemented or rearranged to best fit a particular implementation of the present invention. Preferably, this GUI is implemented in a web-based fashion.

In region 56, the auditor is provided with functionality for querying a database of previously scheduled audits. Search criteria may include a technology or auditor ID code, a currency type, country, telephone number, and audit date. Example query results are provided in region 58. Table 2 below includes a description of various types of information that may be presented and/or input through region 58.

TABLE 2

| Information | Description |
|---|---|
| Supplier Code | Supplier identifier code. |
| Claim Number | Claim identifier number. |
| Line Item Number | A claim may have more than one line |
| | item. |
| PA Stat-Physical Audit | For example, may be updated from “1” |
| Status. | to “3”, “2” to “3”, “3” to “1” (if no |
| | audit schedule date), “3” to “2” (if |
| | audit schedule date exists), or “4” |
| | to “3” (until DAS is issued). |
| Verified Date | The date the claim was verified |
| | (described above). |
| Audit Date | The date the claim was audited. |
| Part Number | The buyer's part number for the |
| | obsolete goods. |
| Part Description | A brief description of the obsolete |
| | goods. |
| Technology Type/Auditor ID | An indicator of the type of |
| | technology or auditor. |
| LIQty-Line Item quantity | Amount of the line item part on the |
| | claim/canvass. |
| PAQty-Physical audit quantity | Quantity identified for the part |
| | after the physical audit. Physical |
| | audit quantity entered is typically |
| | not more than line item quantity. |
| VarQty-The variance quantity | Difference between the Line item |
| | quantity and Physical Audit quantity. |
| Currency Code | The supplier's currency type. |
| Unit Cost | The originally-contracted unit cost |
| | for the part. |
| Negotiated Unit Cost | The negotiated unit cost for the part |
| | that the auditor and supplier agreed |
| | upon during the audit. |
| Salvage | Scrap or Salvage the part. The part |
| | is of no use and needs to be |
| | scrapped. |
| Negotiated Salvage Offer | The offer for the salvage or scrap of |
| | the part by a supplier (scrap |
| | disposing of part). |

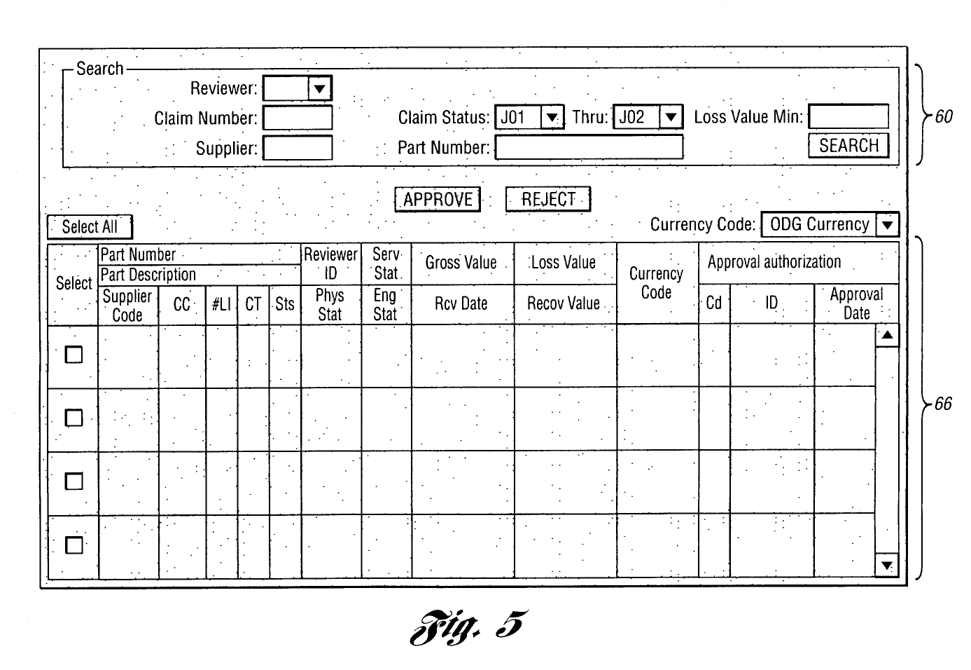

FIG. 5 is an example GUI through which details associated with a supplier claim and corresponding audit are reconciled. The example interface illustrated in FIG. 5 also provides a user (e.g., a claim/audit reviewer) with functionality for approving or rejecting payment for an audited claim and disposal of the obsolete goods. Notably, the content or arrangement of the GUI illustrated in FIG. 5 may be modified, supplemented or rearranged to best-fit a particular implementation of the present invention. Preferably, this GUI is implemented in a web-based fashion.

In region 60, a reviewer can query a database of audited claims by criteria including claim number, claim status, supplier code, part number and minimum loss value. Query results are presented in region 66. Table 3 below includes a description of various types of information that may be presented through region 66. According to one embodiment of the present invention, information is presented in FIG. 5.

TABLE 3

| Information | Description |
|---|---|
| Part Number | The buyer's part number for the |
| | obsolete goods. |
| Part Description | A brief description of the obsolete |
| | goods. |
| Line Item Number | A claim may have more than one line |
| | item. |
| Supplier Code | Supplier identifier code. |
| CC | Claim or Canvass Number-Sequential |
| | number to differentiate one canvass |
| | form another or one claim from |
| | another. |
| CT-Claim Type | Example claim types are ‘A’ for |
| | Purchase Part Claims, ‘B’ for |
| | Component Part Termination Notice |
| | Claims, ‘C’ for Part Sample Warranty |
| | Claims. Then, Canvassed parts are |
| | Claim type ‘P’ and ‘D’ represents a |
| | Pre-Da Canvassed part. (Predisposing |
| | of parts prior to the part being |
| | canvassed automatically by the |
| | Canvass process.) |
| Sts-Claim Status | Claim Status (e.g., A01 thru M02) |
| Reviewer ID | The person reviewing the audited |
| | claim for approval or rejection. |
| Phys Stat | Physical Audit Status: (e.g., has the |
| | audit been completed or bypassed. |
| | Either ‘O’-open ‘I’-Inprocess ‘C’ |
| | closed.) |
| Serv Stat-Service Status | Opened or Closed: Manual reminder to |
| | tell the auditor to contact buyer |
| | customer service division to see if |
| | they want the part. After sending |
| | the claim/canvass to the buyer |
| | customer service division, the |
| | auditor waits for a reply if they |
| | want it. Whether the response is |
| | ‘Yes’ or ‘No’ he/she closes the |
| | indicator. |
| Eng Stat | Open or Closed: May be implemented |
| | to alert/inquire engineering |
| | department regarding need for the |
| | part. |
| Currency Code | The supplier's currency type. |
| Gross Value | Value of all the line item parts |
| | quantity and cost to the buyer. |
| Loss Value | Gross claim value-recovery/salvage |
| | cost of all line item parts on the |
| | claim. |
| Rcv Date | Date the claim was received by the |
| | system. |
| Recovery Value | Value in dollars received by buyer |
| | for the disposing of the part. |
| Approval Authorization | Authorization to pay supplier for |
| | obsolete goods and to dispose of |
| | same. |
| Cd | Approval code or identifier. |
| Approver ID | Name of the individual approving |
| | payment for the claim. |
| Approval Date | Date on which the approval was made. |

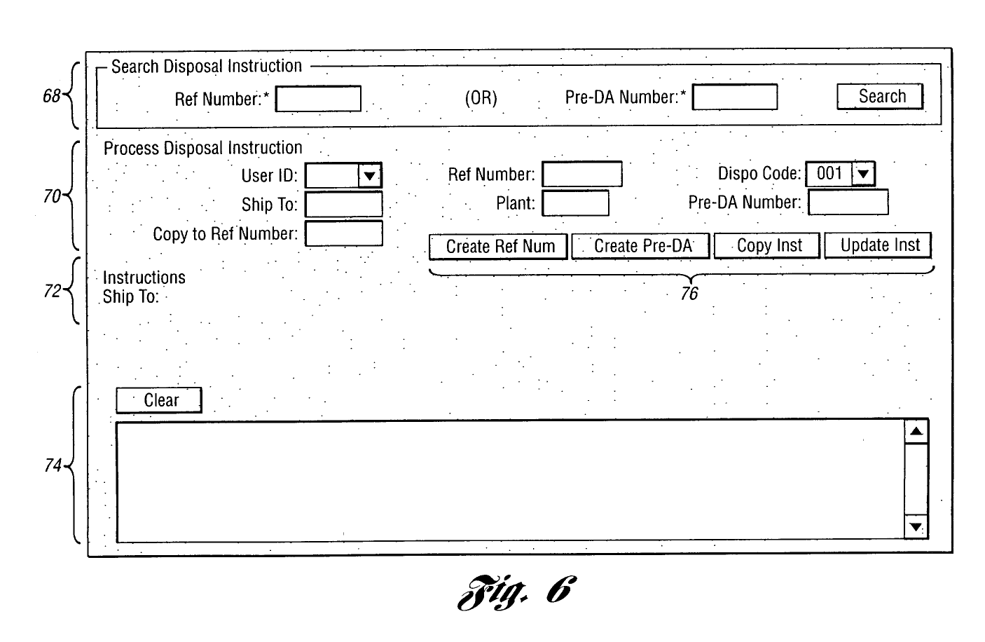

FIG. 6 is an example GUI through which instructions on how the supplier is to dispose of obsolete goods are input. Notably, the content or arrangement of the GUI illustrated in FIG. 6 may be modified, supplemented or rearranged to best fit a particular implementation of the present invention. Preferably, this GUI is implemented in a web-based fashion.

In region 68, a user may query a database of predefined disposal instructions. Predefined instructions may be searched by criteria including reference number and pre-Disposal Authorization or “Pre-DA” number—a sequential number to differentiate one PRE-DA from another.

In region 70, a user may begin creating a new disposal instruction. Input data may include a user ID, a reference number for the disposal instruction, a disposal code (indicates how a part will be disposed of: e.g., ship to supplier, scrap, sale to other, stock transfer, supplier rework at supplier location etc.), a ship-to address, a plant code, a pre-DA number, a copy-to reference number (copies disposal instructions identified by a reference number to another disposal instruction), etc. Utilizing command buttons 76, a user can create a new reference number, create a new pre-DA number, copy instructions, and update existing instructions. In one embodiment, disposal instructions can be created generally for a supplier and disposal code identified by a reference number. Then, this reference number disposal instruction can be copied over (overlay) another reference number disposal instruction.

Region 72 is a preview for the instructions. These are the instructions that the supplier will ultimately receive (as discussed in greater detail below). Region 74 is a free-form text field in which the user can input the text of the instructions.

Notably, obsolete goods may be “disposed of” in a variety of manners. For example, the goods may be shipped to buyer service facilities for servicing buyer products that are currently on the market, goods may be recycled, goods may be disassembled and individually disposed of, and goods may be scrapped or sold for salvage. Additionally, a different set of disposal instructions may be defined for each line item on a supplier's approved claim (not shown).

After a supplier's claim has been approved and the disposal instructions have been defined, a disposal authorization and settlement (“DAS”) form or report is sent to the supplier setting forth the final disposition of the supplier's claim. The DAS report (not shown) may contain information including but not limited to: the supplier's address, a DAS number, an issue date, a charge account number, a currency code, a total settlement amount, the identification and contact information for the person or entity issuing the DAS, and, by line item: a description of the supplier's claim(s), disposal instructions, claim type, the original claim value, a recovery value, a settlement amount, a buyer code, a disposition authorization, and line item payment. A subset of this information and/or a variety of other information may also be provided to best fit a particular implementation of the present invention. The DAS may be communicated to the supplier in a variety of manners including, but not limited to, e-mail, supplier web access, postal mail, facsimile, etc. Similarly, payment for the disposed goods may be via conventional check, credit, electronic payment, etc.

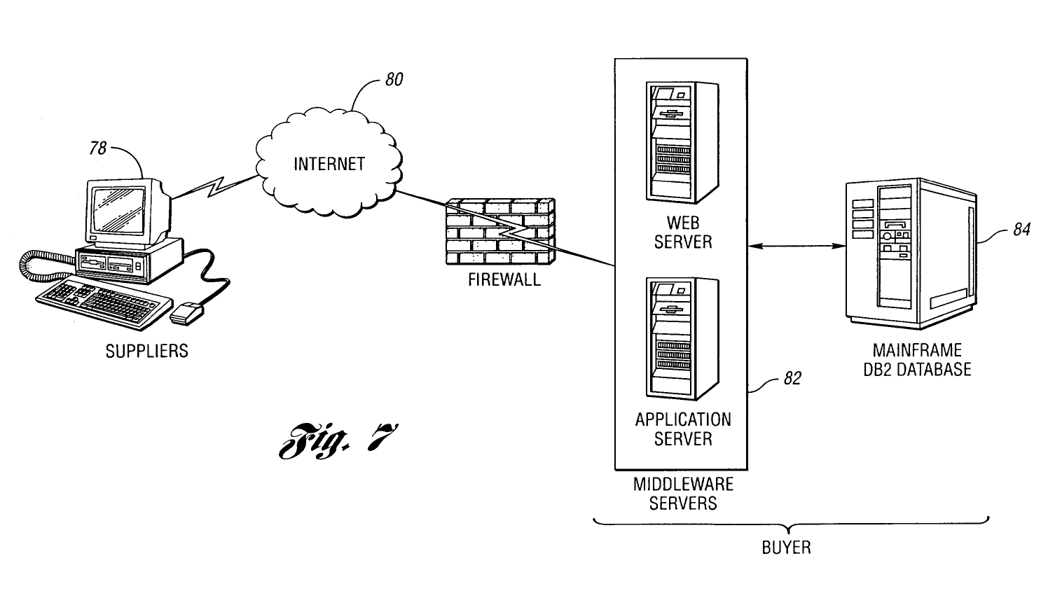

FIG. 7 is a schematic representation of an example system implementation of the present invention. Notably, aspects of the schematic illustrated in FIG. 7 may be adapted or modified to best fit a particular implementation of the present invention. Suppliers 78 access real-time data maintained in buyer databases 84 via internet connectivity 80 and middleware servers 82. Preferably, system embodiments of the present invention are implemented in a multi-tier architecture utilizing J2EE technology. In this manner, suppliers, auditors, reviewers, etc., can access mainframe data in a real-time fashion without the need for a proprietary or closed network connection. In this manner, data may be maintained in a single-source repository thereby minimizing the need for replicating data in separate client/server or middleware databases.

While the best mode for carrying out the invention has been described in detail, those familiar with the art to which this invention relates will recognize various alternative designs and embodiments for practicing the invention as defined by the following claims.

What is claimed:

1. A system for processing obsolete goods in a supply chain, the system comprising an Internet based client-server computing architecture, the architecture operably configured to:
receive input via one or more graphical user interfaces defining a supplier's claim for payment for obsolete goods;
receive input via one or more user interfaces scheduling an audit of the supplier's claim; and
receive input via one or more graphical user interfaces defining one or more results of the audit; and
presenting output reconciling the supplier's claim for payment for the obsolete goods and the audit results.

2. The system of claim 1 wherein the architecture is additionally configured to receive input via one or more graphical user interfaces approving payment for the obsolete goods.

3. The system of claim 1 wherein the architecture is additionally configured to receive input via one or more graphical user interfaces defining disposal instructions for the obsolete goods.

4. The system of claim 1 wherein the architecture is additionally configured to query one or more databases operably configured to store at least a portion of the input information.

5. The system of claim 1 wherein the architecture is additionally configured to print at least a portion of the input information.

6. The system of claim 5 wherein the information is printed in a report format.

7. A method for processing obsolete goods in a supply chain, the method comprising;
establishing a contractual arrangement between a buyer of goods and a supplier of the goods such that the supplier is obligated to supply a quantity of the goods and the buyer is obligated to pay for the quantity of the goods;
communicating to the supplier that a portion of the quantity of the goods are obsolete;
receiving an electronic claim from the supplier over a computer network requesting payment for the obsolete goods;
scheduling an audit of the supplier's claim in an electronic fashion over the computer network;
auditing the supplier's claim wherein the results of the audit are recorded in an electronic fashion over the computer network; and
paying the supplier for the obsolete goods.

8. The method of claim 7 additionally comprising defining disposal instructions for the obsolete goods and communicating the disposal instructions to the supplier.

9. The method of claim 7 additionally comprising verifying the supplier's claim wherein the buyer confirms that the portion of the quantity of the goods are obsolete with regard to the buyer's entire enterprise.

10. The method of claim 7 wherein the step of auditing the supplier's claim includes negotiating a payment price for the obsolete goods.
